(19) United States
(12) Patent Application Publication
(10) Pub. No.: US 2026/0320537 A1
(43) Pub. Date: Oct. 15, 2026

(54) INTEGRATION OF ROBOTIC MANIPULATOR ARMS ONTO AUTONOMOUS MATERIAL HANDLING VEHICLES WITH MULTI-MODAL END EFFECTORS AND FLEET-WIDE MANIPULATION LEARNING

(71) Applicant: ATLAS ROBOTICS AND AUTOMATION, INC., Pittsburgh, PA (US)

(72) Inventors: Çetin Alp Meriçli, Pittsburgh, PA (US); Tekin Alp Meriçli, Pittsburgh, PA (US); Halit Bener Suay, Pittsburgh, PA (US)

(21) Appl. No.: 19/569,814

(22) Filed: Mar. 17, 2026

Related U.S. Application Data
(60) Provisional application No. 63/778,946, filed on Mar. 27, 2025.

(51) Int. Cl. G06Q 10/08; B25J 5/00; B25J 9/16; B25J 13/08; B25J 15/04; B25J 19/00; B66F 9/06; B66F 9/075; G05D 1/246; G05D 1/667; G05D 107/70; G06Q 10/0631

(52) U.S. Cl. CPC G06Q 10/08; B25J 5/007; B25J 9/163; B25J 9/1669; B25J 9/1676; B25J 9/1682; B25J 15/0466; B25J 19/0025; B66F 9/063; B66F 9/0755; G05D 1/246; G05D 1/667; G06Q 10/06313; B25J 13/083; B25J 13/084; B25J 13/085; B25J 13/086; G05D 2107/70

(57) ABSTRACT

An autonomous material handling system integrates one or more robotic manipulators onto a mobile platform such as an autonomous forklift or pallet jack. In a preferred bi-manual configuration, coordinated dual-arm operations enable cooperative grasping, stabilize-and-grasp case picking, and simultaneous independent manipulation. A hierarchical perception system with sensors at platform, manipulator, and end effector levels provides object detection, pose estimation, and grasp quality evaluation. The system autonomously performs case picking, palletizing, depalletizing, and pallet transport without manual reconfiguration. A hierarchical safety architecture leverages the host platform's sensing to detect and track obstacles, environmental structures, and humans at range, supplementing manipulator-level and contact-level safety. In some embodiments, automated tool coupling enables autonomous end effector exchange. Each system learns manipulation policies from operational experience and shares learnings fleet-wide through distributed learning, creating a compounding flywheel where collective manipulation intelligence grows with fleet size.

### CROSS-REFERENCE TO RELATED APPLICATIONS

This application claims the benefit of priority to U.S. Provisional Patent Application No. 63/778,946, filed Mar. 27, 2025, entitled “INTEGRATION OF ROBOTIC ARMS WITH MULTIPLE END EFFECTORS ON AN AUTONOMOUS FORKLIFT FOR VARIOUS INTRALOGISTICS USE CASES,” the entire disclosure of which is incorporated herein by reference.

### TECHNICAL FIELD

The present disclosure relates generally to autonomous material handling systems, and more particularly to mobile robotic platforms equipped with bi-manual multi-degree-of-freedom manipulators for dexterous manipulation, perception systems with artificial intelligence-driven object recognition and grasp planning, and fleet-wide coordination with distributed learning capabilities for warehouse automation.

### BACKGROUND

### Field of the Disclosure

Traditional warehouse operations rely heavily on human operators for material handling tasks including pallet transport, case picking, palletizing, and depalletizing. Conventional forklifts require skilled operators to navigate warehouse environments, position vehicles precisely, and manipulate loads safely. While autonomous mobile robots (AMRs) and automated guided vehicles (AGVs) have emerged to address warehouse automation needs, existing solutions typically focus on either pallet-level transport or case-level manipulation, but not both within a single integrated system.

### Description of Related Art

### Autonomous Mobile Robots and Forklifts

U.S. Pat. No. 8,965,561 to Jacobus et al. describes automated warehousing using robotic forklifts, including drive-by-wire operation of conventional lift trucks with sensor fusion for positioning and laser radar for obstacle detection. However, this system lacks robotic manipulation arms for case-level picking, multi-modal end effectors, automated tool exchange mechanisms, and fleet-wide learning architectures for continuous improvement of manipulation strategies.

U.S. Pat. No. 7,912,574 to Wurman et al. discloses a system and method for transporting inventory items using independently-operating mobile drive units that dock with inventory holders and transport them between locations. While this system enables autonomous navigation and coordinated inventory transport, it does not provide robotic manipulation capabilities for case-level picking, palletizing, or depalletizing operations, requiring separate systems or manual intervention for these tasks.

### Integrated Mobile Manipulator Systems

U.S. Pat. No. 12,251,831 to Murphy et al. (Boston Dynamics, Inc.) describes an integrated mobile manipulator robot comprising a mobile base and a robotic arm mounted thereon for manipulating objects in warehouse environments. While this system integrates a manipulator onto a mobile platform, it employs a single robotic arm rather than a bi-manual configuration capable of coordinated dual-arm operations such as cooperative grasping, stabilize-and-grasp case picking, and simultaneous independent manipulation. Furthermore, this system does not provide automated tool coupling mechanisms for autonomous end effector exchange, does not implement a hierarchical safety architecture that leverages the host platform's multi-modal sensing to proactively detect obstacles and humans at range and supplement manipulator-level safety, does not incorporate fleet-wide distributed learning architectures enabling robots to share manipulation experiences and continuously refine grasp strategies across deployed units, and is not integrated onto a heavy-duty material handling platform such as an autonomous forklift or pallet jack capable of combined pallet-scale transport and case-level manipulation within a single system.

U.S. Pat. No. 9,785,911 to Galluzzo et al. (IAM Robotics, LLC) discloses a system and method for piece-picking or put-away using a mobile manipulation robot with an integrated robotic arm, vision system, and navigation capabilities. However, this system employs a single manipulator arm without bi-manual coordination capabilities, does not provide multiple interchangeable end effectors with automated tool coupling for task-specific end effector selection, and lacks fleet-wide learning architectures that aggregate manipulation experiences across deployed units to create compounding collective intelligence. Additionally, the system is not integrated onto a heavy-duty material handling platform such as an autonomous forklift or pallet jack capable of pallet-scale transport, limiting its applicability to piece-level operations without the ability to perform both pallet handling and case-level manipulation within a single autonomous system.

### Robotic Manipulation Systems

U.S. Pat. No. 10,207,402 to Levine et al. teaches deep machine learning methods for robotic grasping, including training a convolutional neural network to predict grasp success probability from visual input and iteratively servoing an end effector based on the predictions. While this system demonstrates AI-driven manipulation with learned grasp quality prediction, it is mounted on a fixed base and does not integrate with heavy-duty forklift capabilities, automated tool changing, multiple interchangeable end effectors, or fleet-wide learning architectures.

U.S. Pat. No. 10,639,792 to Vijayanarasimhan et al. describes deep machine learning methods for robotic grasping that combine grasp quality prediction with semantic object recognition using interconnected neural networks. However, this system employs a single end effector and does not provide automated tool exchange mechanisms, multi-modal manipulation capabilities (pallet handling, case picking, palletizing), or integration with mobile forklift platforms.

### Tool Changing and Multi-modal End Effectors

U.S. Pat. No. 8,005,570 to Gloden et al. discloses a robotic tool changer comprising a master unit and tool unit with fluid-actuated locking mechanisms, rolling member retention, and utility pass-through for electrical, pneumatic, and data connections. While this system enables end effector exchange, it does not integrate with mobile platforms, lacks AI-driven end effector selection based on object properties, and does not implement fleet-wide learning for manipulation strategies.

U.S. Pat. No. 9,911,640 to Kesil et al. describes a universal gripping and suction chuck combining vacuum suction, vortex-based contactless holding, and mechanical edge gripping within a single end effector housing, with sensors and a processor for automatic modality selection. However, this system provides a single hybrid end effector rather than a plurality of specialized, interchangeable end effectors optimized for different tasks, lacks automated tool exchange capabilities, and does not integrate with mobile platforms or fleet learning systems.

### Fleet Coordination and Distributed Learning

U.S. Pat. No. 10,960,539 to Kalakrishnan et al. describes control policies for robotic agents, including training a global policy neural network from locally optimized controllers across multiple task instances to enable contact-rich manipulation. While this system demonstrates distributed learning concepts for manipulation, it does not address multi-modal end effector selection, automated tool exchange, integration with mobile forklift platforms, or mechanisms for sharing manipulation-specific knowledge such as grasp success rates across heterogeneous end effector types.

U.S. Pat. No. 11,092,973 to Voorhies et al. describes coordinated operation of autonomous robots in warehouse environments, including clustered task partitioning that dynamically allocates retrieval operations across multiple robots to minimize traversal distance and balance workload. However, this system focuses on task allocation and path planning for mobile platforms without addressing robotic manipulation learning, does not provide mechanisms for sharing learned manipulation experiences, and lacks AI-driven grasp planning or federated learning architectures for distributed manipulation policy refinement.

### Limitations of Existing Art

The prior art systems fail to provide an integrated solution combining (1) heavy-duty mobile forklift capabilities for pallet-scale transport, (2) bi-manual multi-degree-of-freedom robotic manipulation for dexterous case-level operations including cooperative grasping, stabilize-and-pick, and simultaneous independent manipulation, (3) AI-driven perception systems for object detection, pose estimation, and grasp quality prediction, (4) intelligent grasp planning leveraging accumulated performance data, and (5) fleet-wide learning architectures enabling robots to share manipulation experiences and continuously refine grasp strategies across deployed units, creating an exponentially growing collective intelligence.

Furthermore, existing robotic manipulation systems typically operate in isolation, with each robot independently learning manipulation policies through expensive and time-consuming training processes. There is no effective mechanism for robots to share learned manipulation experiences across a fleet, resulting in duplicated learning efforts and slow adaptation to novel objects or warehouse configurations. As warehouse robotics fleets grow, this lack of shared learning represents an increasingly significant inefficiency; that is, each new robot must learn from scratch rather than benefiting from the accumulated experience of all previously deployed units.

The integration of bi-manual manipulation capabilities onto a mobile forklift platform for case picking, palletizing, and depalletizing presents significant technical challenges including: (1) structural integration of multiple heavy-duty robotic arms on mobile bases without compromising stability; (2) coordinated bi-manual control including inter-arm collision avoidance and synchronized manipulation; (3) coordinated control of simultaneous base navigation and dual-arm manipulation; (4) perception systems capable of identifying diverse objects ranging from individual cases to full pallets; (5) AI-driven grasp planning accommodating varying object geometries, poses, weights, and surface properties across two manipulators; (6) safety systems enabling operation in human-shared warehouse environments; and (7) fleet-wide learning architectures that efficiently aggregate and distribute manipulation knowledge across multiple deployed units.

Accordingly, there exists a need for an autonomous material handling system that integrates bi-manual dexterous manipulation onto mobile forklift platforms for autonomous case picking and palletization, employs advanced perception and AI-driven grasp planning, operates safely alongside human workers, and leverages fleet-wide learning to continuously improve performance across all deployed units.

### SUMMARY OF PREFERRED EMBODIMENTS

The present disclosure addresses the aforementioned needs by providing an autonomous material handling system comprising a mobile forklift platform with integrated bi-manual robotic manipulators for dexterous manipulation, multi-modal perception systems, AI-driven object recognition and grasp planning, and fleet-wide coordination with distributed learning for manipulation policy refinement. In some embodiments, the system further comprises interchangeable end effectors with automated tool coupling mechanisms enabling task-specific end effector selection.

In one aspect, an autonomous material handling system comprises: a mobile robotic platform having autonomous navigation capability; at least two multi-degree-of-freedom robotic manipulators mounted on said mobile robotic platform and configured for coordinated bi-manual manipulation; end effectors mounted on said robotic manipulators; a perception system comprising at least one of: vision sensors, depth sensors, and force sensors, configured to identify objects and determine grasp strategies; a control system configured to: (a) coordinate said at least two robotic manipulators for bi-manual manipulation tasks including cooperative grasping, simultaneous pick-and-place, and stabilize-and-grasp operations, (b) plan grasp approaches based on output from said perception system, and (c) execute manipulation using the coordinated manipulators; and a fleet coordination module configured to share manipulation data with other autonomous material handling systems and refine said grasp strategies based on fleet-wide experience, wherein manipulation performance improves as the number of deployed systems in the fleet increases.

In another aspect, a method for autonomous material handling comprises: navigating a mobile robotic platform to a target location in a warehouse environment; detecting, using a perception system, one or more objects at said target location; classifying said one or more objects to determine object properties including at least: object type, pose, dimensions, and surface characteristics; coordinating at least two robotic manipulators to plan a bi-manual grasp configuration based on said object properties and a grasp quality model; executing a manipulation operation using said coordinated manipulators; recording an outcome of said manipulation operation; and sharing said outcome with a fleet of autonomous material handling systems to refine said grasp quality model across said fleet, thereby contributing to a fleet-wide learning flywheel that continuously improves manipulation capability as fleet size and operational experience grow.

In yet another aspect, a method for distributed learning of robotic manipulation policies across a fleet of autonomous material handling systems comprises: at a first autonomous material handling system: executing a plurality of manipulation operations using a local manipulation policy; recording, for each manipulation operation: sensor data, manipulation parameters, and an outcome indicator; updating a local manipulation model using said recorded data; generating model update data representing refinements to said local manipulation model; transmitting said model update data to a central aggregation server; at said central aggregation server: receiving model update data from a plurality of autonomous material handling systems in said fleet; aggregating said model update data to generate a global manipulation policy; distributing said global manipulation policy to said plurality of autonomous material handling systems; and at said first autonomous material handling system: receiving said global manipulation policy; incorporating said global manipulation policy into said local manipulation policy; and executing subsequent manipulation operations using said updated local manipulation policy, whereby each additional deployed system contributes new manipulation experiences that improve the global policy, creating an exponentially growing collective intelligence as fleet size increases.

These and other aspects, features, and advantages of the present disclosure will become more fully understood from the following detailed description when read in conjunction with the accompanying drawings.

### BRIEF DESCRIPTION OF THE DRAWINGS

FIG. 1 is an illustration of an autonomous material handling system with integrated bi-manual robotic manipulators according to one embodiment.

FIG. 2 is a block diagram of the perception and grasp planning pipeline.

FIG. 3 is a schematic of the fleet coordination system and distributed learning framework.

FIG. 4 is a flowchart depicting a method for autonomous material handling.

### DETAILED DESCRIPTION OF PREFERRED EMBODIMENTS

The following detailed description presents multiple embodiments of the disclosure. It should be understood that the described embodiments are merely examples and that the disclosure encompasses variations and modifications apparent to those skilled in the art. Unless otherwise defined, all technical and scientific terms used herein have the same meaning as commonly understood by one of ordinary skill in the art to which this disclosure belongs.

### 1. System Overview

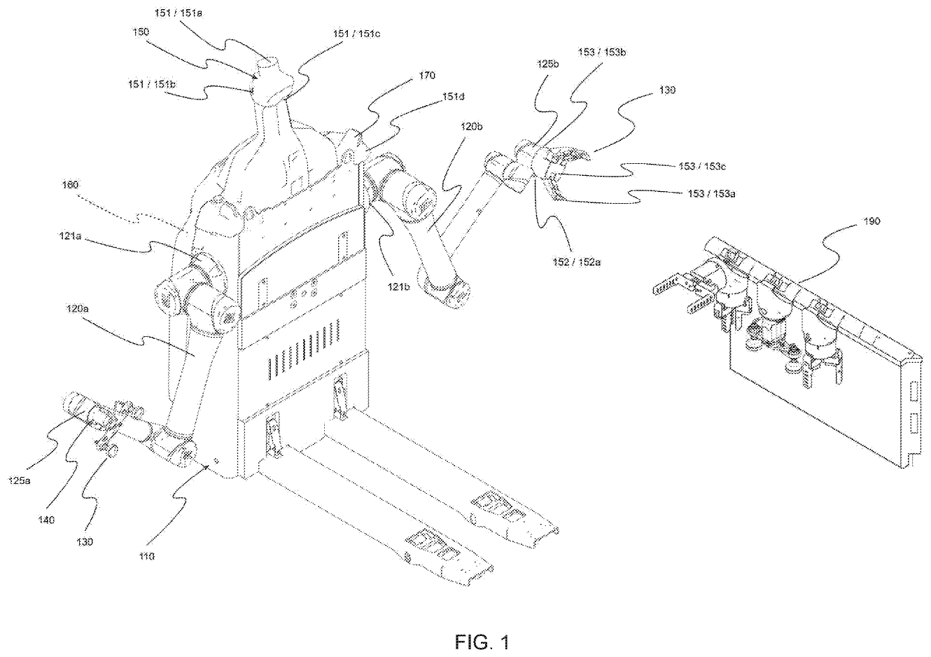

Referring to FIG. 1, an autonomous material handling system (100) according to one embodiment comprises a mobile robotic platform (110), a pair of robotic manipulators (120a, 120b) mounted on the mobile platform (110) in a bi-manual configuration, end effectors (130) mounted on each manipulator, a perception system (150), a control system (160), and a fleet coordination module (170). In some embodiments, the system further comprises an automated tool coupling mechanism (140) and a plurality of interchangeable end effectors enabling task-specific end effector exchange.

The mobile robotic platform (110) may comprise an autonomous forklift configured for heavy-duty material handling in warehouse environments. In preferred embodiments, the forklift base is capable of navigating autonomously using onboard sensors including LiDAR, cameras, and inertial measurement units (IMUs), utilizing onboard localization algorithms to maintain precise position awareness. Localization approaches may include, for example, simultaneous localization and mapping (SLAM), pre-built map-based localization, beacon or fiducial-based positioning, or combinations thereof. The forklift retains standard pallet handling capabilities including lift mechanisms capable of raising palletized loads to heights suitable for warehouse rack systems (depending on mast configuration) and carrying payloads appropriate for palletized material handling.

Alternatively, the mobile robotic platform (110) may comprise other autonomous mobile bases including autonomous pallet jacks, automated guided vehicles (AGVs), autonomous mobile robots (AMRs), mobile robotic carts, or specialized warehouse vehicles. The key characteristic is autonomous navigation capability without requiring fixed guidance infrastructure such as magnetic strips or guide wires.

The robotic manipulators (120a, 120b) are mounted to the mobile platform (110) via mounting structures (described in detail in Section 4). In preferred embodiments, each manipulator comprises a serial-link robotic arm having 6 or 7 degrees of freedom (DOF), enabling comprehensive positioning and orientation of end effectors within a workspace envelope. For example, a 6-DOF manipulator may provide 3 DOF for position (x, y, z) and 3 DOF for orientation (roll, pitch, yaw), while a 7-DOF manipulator adds redundancy enabling collision avoidance while maintaining end effector pose. The bi-manual configuration enables coordinated dual-arm manipulation tasks including: cooperative grasping of large or heavy objects using both arms simultaneously; stabilize-and-grasp operations where one arm stabilizes a pallet or stack while the other picks individual cases; simultaneous independent pick-and-place for increased throughput; and coordinated palletizing where one arm holds a case in position while the other adjusts placement.

Each manipulator (120a, 120b) has a reach sufficient to enable access to pallet racks, shelves, and conveyor systems commonly found in warehouse environments. The payload capacity of each arm is sufficient for handling individual cases, boxes, and bags typically encountered in warehouse operations. Higher payload variants may be employed for handling multiple cases simultaneously or heavy industrial components.

Joint actuators may comprise servo motors (brushless DC or AC servo), harmonic drive gear reducers for high torque in compact form factors, and absolute position encoders providing repeatability suitable for warehouse manipulation tasks. Each manipulator includes a wrist joint (125a, 125b) at the distal end to which end effectors are mounted. Force/torque sensors may be integrated at the wrist joints and/or within each joint to enable compliant manipulation and human-safe collaborative operation.

End effectors (130) are mounted on each manipulator wrist. Each end effector employs a grasping modality suited to the manipulation task at hand. Grasping modalities include, but are not limited to: jaw-based gripping using parallel-jaw grippers for grasping cases, boxes, and containers; vacuum suction using suction arrays for engaging smooth-surfaced items; multi-finger articulated gripping using dexterous multi-fingered hands for complex geometries; compliant gripping using soft or deformable elements for fragile or irregularly shaped objects; magnetic gripping for ferrous materials; and hybrid configurations combining multiple modalities such as jaw-based gripping and vacuum suction within a single end effector. In a preferred embodiment, each arm may be equipped with a different end effector type suited to its role; for example, one arm with an articulated gripper for case picking and the other with a vacuum suction array for palletization.

In some embodiments, the system further includes an automated tool coupling mechanism (140), which enables rapid, autonomous exchange of end effectors without human intervention. The coupling mechanism (140) (described in detail in Section 2) provides mechanical connection, electrical signal pass-through, pneumatic passage connections (if applicable), and communication interfaces between the manipulator wrist and the end effector. When the automated tool coupling mechanism is included, each manipulator can autonomously change its end effector based on task requirements.

The perception system (150) comprises multiple sensor modalities providing comprehensive environmental awareness and object understanding. Base-mounted sensors (151) attached to the mobile platform (110) provide wide-area perception for navigation and coarse object detection, including LiDAR sensors (151a) and RGB-D cameras (151b). Manipulator-mounted sensors (152) attached to each robotic arm (120a, 120b), particularly near the wrist joints (125a, 125b), provide fine-grained perception for precise manipulation, including high-resolution RGB-D cameras (152a). End effector-integrated sensors (153) provide real-time feedback during grasping and manipulation, including tactile sensors (153a), force/torque sensors (153b), and proximity sensors (153c).

Sensor types may include: RGB cameras for color image acquisition; depth cameras (RGB-D) using structured light, time-of-flight (ToF), or stereo vision for 3D scene understanding; LiDAR sensors providing precise point cloud data; infrared (IR) cameras for low-light operation; force/torque sensors measuring interaction forces; tactile sensors detecting contact location, pressure distribution, and slip; and inertial measurement units (IMUs) providing acceleration and angular velocity data.

The control system (160) comprises computational hardware and software executing perception algorithms, bi-manual motion planning and coordination, manipulation control, and fleet coordination. Computational hardware may include industrial computers with multi-core processors, graphics processing units (GPUs) for neural network inference, and field-programmable gate arrays (FPGAs) for real-time control loops. The control system coordinates both manipulators (120a, 120b) for bi-manual tasks, including collision avoidance between arms, synchronized motion planning, and task-role assignment (e.g., designating one arm as stabilizer and the other as picker). Software architecture may be implemented using robot middleware, providing modular architecture, inter-process communication, and extensive libraries for perception, planning, and control.

The fleet coordination module (170) enables communication and coordination among multiple autonomous material handling systems (100) deployed within a warehouse facility. The module (170) interfaces with a centralized fleet management system (FMS) via wireless communication networks. Functions include task allocation, path coordination for collision avoidance, shared environment mapping, and most notably, distributed learning for manipulation policies (described in detail in Section 8).

### 2. Automated Tool Coupling Mechanism

In embodiments where the system includes interchangeable end effectors, the automated tool coupling mechanism (140) enables rapid, autonomous exchange between end effectors (130) without human intervention. The mechanism comprises a master plate affixed to each robotic manipulator wrist (125a, 125b) and a tool plate affixed to each end effector (130).

In one embodiment, the master plate comprises a hardened steel mounting interface conforming to ISO 9409-1 standards or a custom bolt pattern. The master plate includes an actuation system for engaging and disengaging the tool plate.

The actuation system may comprise pneumatic actuators utilizing compressed air at operational pressures to drive locking pins that engage with corresponding receptacles in the tool plate. Alternatively, electric actuators such as brushless DC motors with cam mechanisms or linear solenoids may be employed. In preferred embodiments, a plurality of locking pins are positioned at regular intervals around the coupling interface to ensure balanced load distribution and prevent rotation under torque.

The locking pins provide suitable retention force ensuring the end effector remains securely attached under dynamic loading conditions including acceleration, deceleration, and manipulation forces. A pull-stud mechanism may be incorporated wherein the tool plate is drawn into contact with the master plate by a central pull rod, ensuring highly repeatable positioning.

The coupling mechanism (140) includes utility pass-through connections providing electrical power, signal communication, and pneumatic passages between the manipulator and end effector. Electrical connections may include: DC power for end effector actuation; low-voltage signal lines for sensors; and digital communication protocols. Pneumatic connections may include: compressed air supply passages at operational pressures; vacuum passages at operational vacuum levels; and pressure sensing lines. Quick-disconnect connectors automatically mate when the end effector is coupled and disconnect when released.

Locking verification is provided by redundant sensors including: proximity switches detecting pin engagement (magnetic, inductive, or optical sensors); force/pressure sensors verifying coupling contact; and electrical continuity sensors confirming utility connections. In safety-critical embodiments, two independent sensors must both confirm secure coupling before manipulation operations are permitted (AND logic gate). Additionally, a tool identification system such as RFID tags or hardwired resistor networks uniquely identifies the coupled end effector, enabling the control system (160) to verify that the correct tool is attached for the intended task.

The coupling mechanism (140) enables rapid end effector exchange. The exchange sequence comprises: (1) navigation of the manipulator to a tool storage rack (190) where multiple end effectors are stored; (2) positioning of the master plate to align with the desired tool plate using visual servoing or fiducial marker detection; (3) controlled contact between master and tool plates; (4) actuation of locking pins to engage tool plate; (5) verification of secure coupling via redundant sensors; (6) automated connection of utility pass-throughs; and (7) verification of tool identity via tool ID system. The inverse sequence releases the current end effector before acquiring a new one.

Safety interlocks prevent manipulation operations if: (a) locking sensors do not confirm secure coupling; (b) utility connections are not established; (c) tool ID does not match expected end effector for the assigned task; or (d) actuator fault is detected. Spring-loaded backup pins engage automatically if primary locking fails, providing fail-safe mechanical retention.

### 3. End Effectors

The present disclosure is not directed to novel end effector designs; rather, the invention concerns the integration of manipulator arms with autonomous end effector selection and exchange onto mobile material handling platforms. Accordingly, the manipulator arms may employ any end effectors suited to the manipulation tasks at hand, including commercially available or custom-designed grippers. End effectors employing different grasping modalities; such as jaw-based grippers, vacuum suction arrays, multi-finger articulated hands, compliant grippers, magnetic grippers, and hybrid configurations combining multiple modalities, may be maintained in a tool storage rack (190) and autonomously exchanged via the automated tool coupling mechanism (140) described in Section 2.

Each end effector preferably includes integrated sensors; such as tactile sensors for contact detection and force distribution, force sensors for grip force feedback, and proximity sensors for pre-contact object detection, enabling the control system (160) to perform closed-loop grasp execution, monitor grasp quality in real-time, and adapt manipulation strategies based on sensor feedback. The specific sensor complement may vary by end effector type and intended application.

### 4. Robotic Arm Integration and Mounting

The robotic manipulators (120a, 120b) must be securely mounted to the mobile forklift platform (110) in a manner that: (1) provides structural rigidity to maintain manipulation accuracy; (2) distributes static and dynamic loads without exceeding chassis stress limits; (3) accommodates vibration and shock from forklift motion; (4) enables required workspace access for manipulation tasks; and (5) provides sufficient separation between the two arms to avoid inter-arm collisions while maintaining overlapping workspaces for cooperative bi-manual manipulation.

### 4.1 Mounting Configurations

Fixed Mast Mounting (FIG. 1): The robotic manipulators (120a, 120b) are mounted to the forklift mast (vertical post structure) or frame via mounting plates (121a, 121b). Each mounting plate comprises a steel plate bolted to both the manipulator base flange and the forklift structure using high-strength bolts. Reinforcement gussets (triangular steel plates) distribute loads from each mounting point to the surrounding structure.

In a preferred bi-manual configuration, the two manipulators are mounted symmetrically on opposite sides of the mast or frame (left and right), providing bilateral workspace coverage and enabling cooperative manipulation of objects in front of the vehicle. Alternatively, both manipulators may be front-mounted at different heights or lateral offsets on a shared mounting bracket.

In alternative embodiments, additional degrees of freedom may be provided at the mounting interface. For example, a pan-tilt base positioned between the platform mounting structure and the manipulator base may provide a pan (yaw) axis for horizontal rotation and a tilt (pitch) axis for vertical tilt, expanding the workspace envelope. As another example, a horizontal linear rail mounted to the platform frame may enable lateral translation of the manipulator base, allowing optimal arm positioning for each task without requiring base navigation adjustments. These and other mounting variations may be employed individually or in combination to extend the manipulators'effective workspace.

### 4.2 Load Distribution and Stability

Integration of two robotic manipulators plus end effectors plus payloads on a mobile forklift creates substantial moment loads that shift the vehicle's center of gravity and may compromise stability. The bi-manual configuration provides the advantage that symmetric arm placement can partially balance lateral moments, but coordinated load management is required when both arms carry payloads simultaneously.

Counterweight Strategy: Counterweight mass is positioned to offset moment loads created by the manipulators and payloads, with counterweight placement determined by the mounting configuration of the arms. For example, in a front-mounted arm configuration, counterweight is added to the rear of the platform; in a rear-mounted or side-mounted configuration, counterweight is placed on the opposing side accordingly. Alternatively or additionally, active stabilization via deployable outriggers (hydraulic legs extending from the platform) provides a wider support base during manipulation.

Dynamic Stability Monitoring: Load cells integrated into platform wheels or suspension measure weight distribution in real-time. The control system (160) continuously evaluates stability by computing net moment loads about potential tipping axes based on the positions and weights of the manipulators, payloads, and counterweights. Because the relevant tipping axis and moment directions depend on the arm mounting configuration (front, rear, side, or combinations thereof), the control system evaluates stability across multiple axes as needed. If the net tipping moment about any axis approaches a configurable safety threshold, the control system restricts manipulator reach, reduces speed, or alerts the operator.

Chassis Reinforcement: The forklift mast and frame are reinforced at manipulator mounting points via: (a) welded gussets to distribute stresses; (b) additional bracing to increase torsional rigidity; and (c) vibration damping mounts (rubber isolators) to protect precision sensors from forklift vibrations during motion.

Finite Element Analysis (FEA): Computer modeling verifies that stress concentrations at mounting points remain within acceptable margins of yield strength under maximum load conditions. Fatigue analysis ensures sufficient cycle life under expected duty cycles.

### 4.3 Cable Management

Power, signal, and pneumatic lines must route from the forklift battery and control systems to both manipulators and their end effectors. Cable tracks protect cables during manipulator motion. For configurations with pan-tilt or linear rail mounting, additional cable length accommodates the extended range of motion.

Internal cable routing through the manipulator joints (when supported by the manipulator design) is preferred to minimize exposure and snag hazards. External cable tracks with strain relief and minimum bend radius specifications ensure sufficient flex cycle life for the expected operational duty cycles.

At the end effector interface, quick-disconnect connectors (Section 2) enable automated connection during tool changes. Keyed connectors prevent incorrect mating. Waterproof connectors (IP67 rated) withstand washdown environments common in food and beverage warehouses.

### 5. Multi-modal Perception System

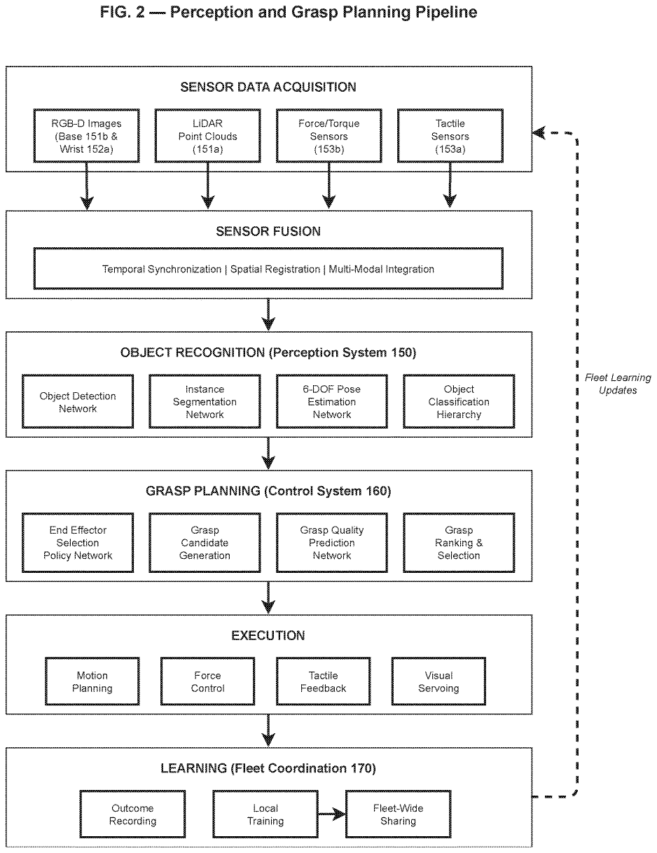

Referring to FIG. 2, the perception system (150) employs multiple sensor modalities to provide comprehensive environmental awareness, object recognition, and manipulation feedback. The perception pipeline comprises sensor data acquisition, sensor fusion, object detection and segmentation, pose estimation, and grasp quality prediction.

### 5.1 Sensor Configuration

### Base-Mounted Sensors (151)

LiDAR sensors (151a) mounted on the forklift chassis provide wide-angle coverage for navigation and obstacle detection. Point cloud data at suitable update rates enables creation of 3D occupancy grids and detection of large objects such as pallets, racks, and forklifts.

RGB-D cameras (151b) mounted at the front and sides of the forklift provide color images and depth maps at operational frame rates. These sensors enable: (a) pallet detection at suitable distances; (b) shelf and rack recognition; (c) warehouse structure mapping; and (d) coarse object segmentation.

In some embodiments, additional base-mounted sensors may be employed to extend perceptual coverage. For example, an array of RGB cameras (151c) may be arranged in a panoramic configuration around the platform body to provide 360-degree situational awareness, enabling continuous object detection, classification, and segmentation in all directions regardless of platform heading. As another example, time-of-flight (ToF) proximity sensors (151d) may be distributed around the platform perimeter to cover blind spots not fully addressed by the primary LiDAR unit, providing short-range depth measurements for near-field obstacle detection and human proximity sensing.

### Manipulator-Mounted Sensors (152)

High-resolution RGB-D cameras (152a) mounted near each manipulator wrist provide fine-grained views of the workspace immediately in front of each end effector. Higher resolution and improved depth accuracy enable: (a) precise object localization for grasp planning; (b) item identification via barcode/QR code reading; (c) verification of pallet structures (individual box positions); and (d) grasp execution monitoring. Having cameras on both manipulators enables simultaneous perception from two vantage points, improving depth estimation and occlusion handling during bi-manual manipulation.

Adjustable FOV lenses or zoom capabilities enable adaptation to different working distances.

### End Effector-integrated Sensors (153)

Tactile sensors (153a) embedded in end effector contact surfaces provide contact detection, force distribution, and slip sensing at configurable sampling rates.

Force/torque sensors (153b) at the manipulator wrist measure 6-axis wrench (3-axis force +3-axis torque) at high sampling rates. This data enables: (a) contact detection during approach; (b) grasp force monitoring; (c) compliant manipulation (force control); and (d) collision detection (unexpected resistance).

Proximity sensors (153c) (infrared or ultrasonic) detect object presence before contact, enabling pre-emptive grasp adjustments.

### 5.2 Object Recognition and Scene Understanding

The perception system (150) fuses data from all sensor modalities, which is temporally synchronized and spatially registered into a common coordinate frame, to create a unified representation of the workspace. The control system (160) processes the fused sensor data to detect and localize objects, outputting bounding boxes, class labels (e.g., “cardboard box”, “plastic tote”, “pallet”, “bag”), confidence scores, and 6-DOF pose estimates (3D position and orientation). Objects are classified by category, physical properties (dimensions, estimated weight, surface material, deformability), and grasp affordances (handles, edges, flat surfaces, graspable openings). This information is passed to the grasp planning module (Section 6) to determine which end effector and grasp strategy to use.

For depalletizing operations, the perception system analyzes pallet structure, identifying individual boxes, layer boundaries, and stacking patterns, and predicts stability to determine safe picking order (removing boxes least critical to overall pallet stability first).

### 6. AI-Driven Grasp Planning

Grasp planning determines: (a) which end effector to use; (b) where to grasp the object; (c) how to approach; and (d) what force/torque to apply. The planning process leverages grasp quality models. In preferred embodiments, the grasp quality models comprise learned models trained on real-world and simulated data, though analytical or heuristic models may also be employed.

### 6.1 End Effector and Arm Role Assignment

The control system (160) assigns roles to each manipulator arm and selects grasp strategies based on the task at hand. In the bi-manual configuration, the control system determines: which arm serves as the primary manipulator and which serves a supporting role (e.g., stabilizing a pallet stack while the other arm picks); whether both arms operate independently on separate objects for throughput or cooperatively on a single object for dexterity; and the grasp strategy for each arm's mounted end effector.

Inputs to the arm role assignment include:—Object Properties: Class, dimensions, weight, surface material, deformability.—Task Type: Pick, place, palletize, depalletize. Environmental Context: Clearance around object, orientation constraints, nearby obstacles.—End Effectors Currently Mounted: The end effector type on each arm. Learned Success Rates: Historical grasp success rate for each object-end effector-arm configuration pair (from fleet grasp library, Section 8).

In embodiments with automated tool coupling, the control system may additionally evaluate whether exchanging an end effector on one or both arms would improve task success, weighing predicted success improvement against time cost of the tool change.

Training data comprises: (a) expert demonstrations where human operators manually label optimal arm roles and grasp strategies; (b) autonomous operation logs where the system tries different arm role assignments and records outcomes; and (c) reinforcement learning (RL) where the policy is refined by maximizing task success rate.

### 6.2 Grasp Synthesis

Given a selected end effector and detected object, the system generates candidate grasps, each defined by a 3D position, orientation, end effector configuration (e.g., jaw width, active suction pads), and collision-free approach trajectory, and evaluates their quality using a grasp quality model. The model predicts success probability based on sensor data, object properties, and the candidate end effector configuration. Candidates are ranked by predicted success probability weighted against task priority and time cost (including any required tool change), and the top-ranked grasp is selected.

During grasp execution, real-time feedback from force/torque sensors and tactile sensors enables adaptive adjustments: correcting asymmetric contact, modulating grip force, detecting slip, and aborting if unexpected resistance indicates a collision or safety concern.

### 6.3 Palletizing and Depalletizing Strategies

Palletizing: When building a pallet, the system determines optimal case placement to maximize volume utilization and stack stability, subject to weight, overhang, and height constraints. Placement patterns may be computed via optimization solvers, learned policies, or rule-based heuristics augmented with corrections from fleet experience.

Depalletizing: The system determines safe removal order based on pallet stability analysis, removing boxes that least impact overall structural integrity first.

### 7. Safety Systems

The autonomous material handling system (100) employs a hierarchical, multi-layered safety architecture that leverages the full onboard sensor suite to detect and respond to obstacles, environmental structures (e.g., warehouse racks, shelving, columns, conveyors), and humans in the operating environment. Because the robotic manipulators (120a, 120b) are mounted on an already autonomous mobile platform (110) equipped with rich multi-modal sensing for navigation and environment understanding, the manipulators do not operate in safety isolation; they benefit from the host platform's continuous spatial awareness of the surrounding environment, including the positions of nearby obstacles and the positions and poses of nearby humans. This is particularly important for preventing collisions between the manipulators and environmental structures such as rack uprights or cross-beams, which could cause damage to the system, the infrastructure, or stored inventory.

The hierarchical safety architecture comprises three detection layers: (1) Platform-level detection: The base-mounted sensors (151), including LiDAR (151a) and cameras (151b), continuously scan the environment during both navigation and manipulation, detecting and tracking obstacles, environmental structures, and humans at range, classifying detected entities, determining positions and in particular human poses, and maintaining a primary safety envelope around the entire system. This layer provides early warning and proactive safety before the manipulators approach any obstacle or human. (2) Manipulator-level detection: The wrist-mounted cameras (152a) and proximity sensors on the robotic arms detect obstacles and human presence within the manipulation workspace at closer range, providing a second layer of safety as the arms operate near environmental structures such as racks, shelves, and conveyors. (3) End-effector-level detection: Force/torque sensors (153b), tactile sensors (153a), and proximity sensors (153c) integrated into the end effectors detect unexpected contact with obstacles, structures, or humans during manipulation, providing the final layer of safety.

Data from all three detection layers is continuously fused by the control system (160) to maintain configurable protective zones surrounding the mobile platform (110) and manipulators (120a, 120b), with zone boundaries dynamically adjusted based on vehicle velocity, manipulator configurations, and payload weights. Detection of an obstacle or human within a warning zone triggers speed reduction; detection within a protective zone triggers an immediate controlled stop. Both manipulators are restricted to retract-only motion when obstacles or humans are detected within the manipulation workspace at any detection layer. The control system also prevents inter-arm collisions by maintaining minimum separation distances between the two manipulators during coordinated operations. Detected humans receive heightened safety priority, including wider protective zones and lower force thresholds, compared to static environmental structures. This hierarchical approach ensures that manipulator safety is not dependent solely on contact-level sensing but is proactively informed by the host platform's broader environmental awareness, preventing collisions with both humans and infrastructure.

Force/torque sensors and tactile sensors continuously monitor interaction forces during manipulation. If unintended contact with an obstacle, environmental structure, or human is detected, the system immediately releases grip force and halts motion. The automated tool coupling mechanism (140) prohibits manipulation unless all redundant locking sensors confirm secure engagement. Emergency stop capability is provided via physical buttons and optionally via wireless pendants.

Spring-applied, electrically-released brakes on manipulator joints and drive motors engage automatically upon power loss (fail-safe design). A multi-level watchdog architecture triggers safe stops upon loss of heartbeat signals at any level.

### 8. Fleet Coordination and Distributed Learning

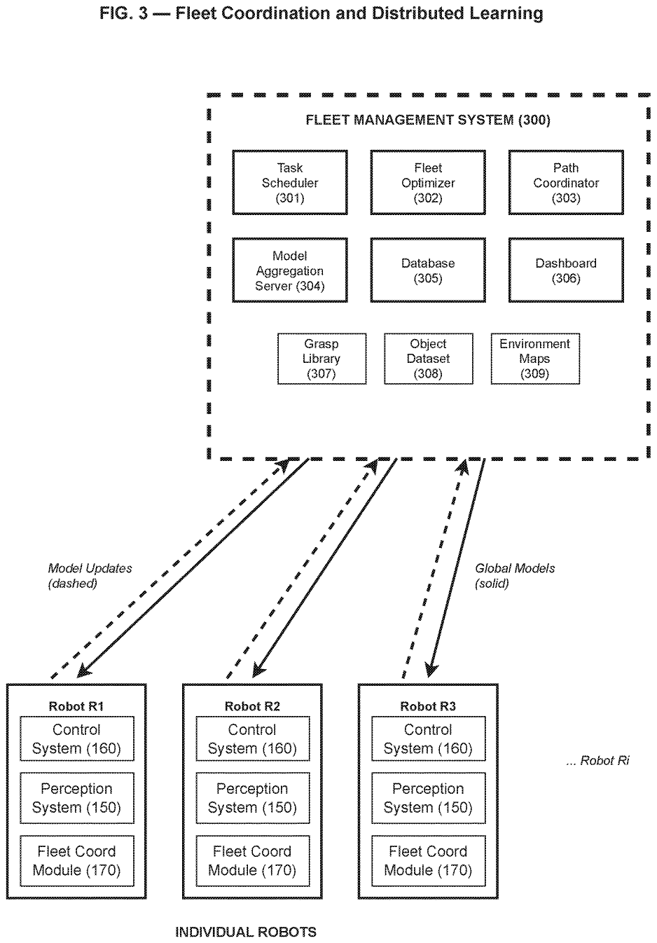

Referring to FIG. 3, the fleet coordination module (170) enables multiple autonomous material handling systems (100) to operate cooperatively within a warehouse facility, sharing workspace, coordinating task allocation, and collectively learning improved manipulation policies through a distributed learning architecture that creates compounding returns as fleet size grows.

### 8.1 Fleet Management System

A centralized Fleet Management System (FMS) (300) coordinates fleet operations. The FMS comprises a task scheduler (301) that assigns material handling tasks to individual robots based on robot positions, battery levels, currently mounted end effectors, and task urgency; a fleet optimizer (302) that coordinates fleet-wide resource allocation and task prioritization; a path coordinator (303) that shares robot positions and planned paths to prevent collisions and deadlocks; a model aggregation server (304) that implements distributed learning (Section 8.2); a shared grasp library database (305) storing manipulation outcomes across the fleet, the database (305) further comprising a grasp library (307), an object dataset (308), and environment maps (309); and a monitoring dashboard (306) providing fleet status visibility to operators. Tasks are dynamically re-assigned when conditions change (new urgent tasks, robot failures, battery depletion).

### 8.2 Distributed Learning for Manipulation Policies

The system implements a distributed learning framework enabling fleet-wide sharing of manipulation knowledge without centralizing raw sensor data. In preferred embodiments, a federated learning approach is employed.

Local Learning: During autonomous operation, each robot records manipulation outcomes with sensor data, end effector type, grasp parameters, and success/failure indicators. The robot periodically fine-tunes its local manipulation models using this recorded data during idle time (e.g., while charging).

Fleet Aggregation: Each robot transmits compact model update data (not raw sensor data) to the model aggregation server (304), which combines updates from multiple robots into an improved global model. In preferred embodiments, model weight deltas are transmitted and aggregated using weighted averaging, though other aggregation methods may be employed. The updated global model is validated and distributed back to all robots, completing the learning cycle.

Shared Grasp Library: A fleet-wide grasp library database stores, for each object type, the grasp configurations and end effector types that have yielded the highest success rates across the fleet. When a robot encounters a detected object, it queries this library to retrieve historically successful grasps. After each manipulation attempt, the robot updates the library with the outcome. Over time, the fleet's collective manipulation capability improves: novel objects learned by one robot become accessible to the entire fleet, and grasp strategies are continuously refined based on accumulated real-world experience.

Fleet Learning Flywheel Effect: The distributed learning architecture creates a compounding flywheel: each deployed robot contributes new manipulation experiences from its operational environment, which are aggregated to improve the global model distributed to all robots. As fleet size increases, the rate of new experience generation grows proportionally; that is, a fleet of N robots generates N times the manipulation data of a single robot, covering a broader diversity of objects, environments, and edge cases. This means each additional robot deployed not only gains the benefit of all prior fleet learning but also accelerates learning for every other robot. The result is an exponentially growing collective intelligence where manipulation performance improves at a rate that accelerates with fleet scale, making early robots immediately more capable as new robots are added and contribute their experiences.

### 9. Method of Operation

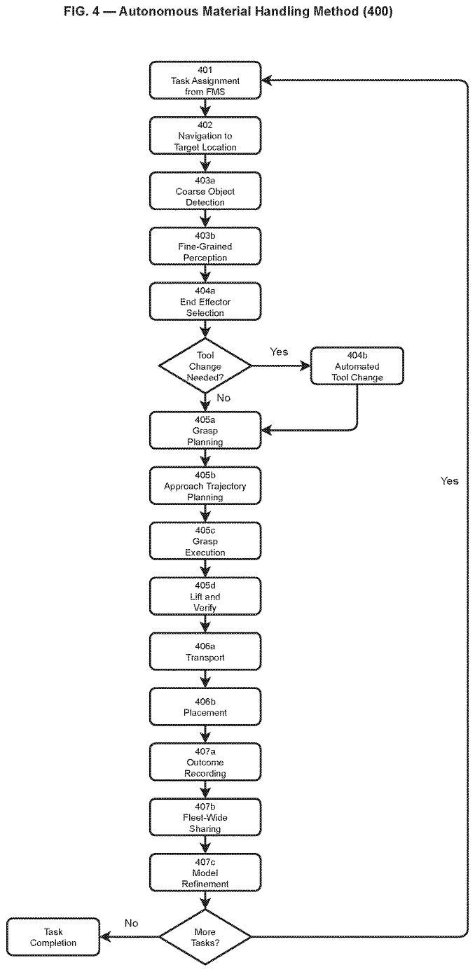

Referring to FIG. 4, a method (400) for autonomous material handling comprises the following steps:

Step (401)—Task Assignment: The FMS (300) assigns a material handling task to the autonomous system (100), specifying object location, manipulation type (pick case, palletize, depalletize, transport pallet), destination, and priority.

Step (402)—Navigation: The mobile platform (110) autonomously navigates to the target location using onboard localization, LiDAR and cameras for obstacle detection, and path planning for trajectory generation.

Step (403)—Perception and Object Detection: Upon arrival, the perception system (150) detects and classifies target objects. Base-mounted sensors perform coarse detection; the manipulators position their wrist-mounted cameras (152a) for fine-grained perception including object detection, 6-DOF pose estimation, and classification of object properties (category, dimensions, weight, surface material).

Step (404)—Bi-Manual Task Planning: The control system (160) assigns roles to each manipulator based on the task. For case picking from a pallet, one arm may stabilize the stack while the other picks the target case. For palletizing, both arms may operate independently to place cases simultaneously, or cooperatively to handle heavy or awkward items. If the system includes an automated tool coupling mechanism (140), the control system may optionally exchange end effectors at the tool storage rack (190) based on detected object properties and task requirements.

Step (405)—Coordinated grasp planning and execution: the system generates candidate grasps for each manipulator, evaluates them using a grasp quality model and fleet grasp library data, and selects the top-ranked grasp configurations while ensuring collision-free paths for both arms. The manipulators execute coordinated approach trajectories, with the control system managing inter-arm collision avoidance and temporal synchronization. Real-time force/torque and tactile feedback from both arms enables adaptive adjustments during grasp execution. Objects are lifted and grasp success is verified via force sensors and visual confirmation.

Step (406)—Transport and Placement: The manipulators retract to stable transport configurations and the forklift navigates to the destination. For palletizing tasks, the system determines optimal case placement coordinates. The manipulators position objects and release them, with sensors verifying successful placement. Bi-manual operation enables higher throughput by allowing one arm to place a case while the other retrieves the next.

Step (407)—Outcome Recording and Fleet Learning: The system logs the manipulation attempt (object properties, end effector used, grasp parameters, arm role assignments, bi-manual coordination strategy, and outcome). Outcomes are transmitted to the FMS (300) to update the shared grasp library and contribute to fleet-wide model refinement (Section 8.2). Each logged experience enriches the fleet's collective intelligence; that is, an object or grasp strategy learned by one robot immediately benefits all robots in the fleet, and the rate of learning accelerates as more robots are deployed. The robot then receives its next task assignment or enters idle mode.

### 10. Alternative Embodiments and Variations

While the foregoing description presents preferred embodiments, numerous variations and alternatives are within the scope of the disclosure.

Mobile Platform Variations: The system may be implemented on alternative mobile bases including: pallet jacks (lower height, lighter payloads), reach trucks (higher lifting heights), order pickers (elevated operator platforms adapted for robotic arms), automated guided vehicles (AGVs), or custom-designed mobile bases optimized for manipulation.

Manipulator Variations: While the preferred embodiment employs a bi-manual (dual-arm) configuration, alternative configurations may include: a single-arm system for simpler tasks or smaller platforms where space or payload constraints limit multi-arm installation; systems with more than two arms for higher throughput or specialized multi-task operations; or anthropomorphic arms with advanced kinematics adapted for industrial payloads.

End Effector Variations: Additional specialized end effectors may include: magnetic grippers for ferrous materials, needle grippers for fabric or bags, soft robotic grippers with pneumatic fingers, or application-specific tooling such as clamps for drums or layer-picking heads for full pallet layers.

### Advantages

The disclosed autonomous material handling system provides the following advantages over prior art:
1. Bi-Manual Dexterity on Mobile Platforms: Integrates dual-arm manipulation onto autonomous forklifts and pallet jacks, enabling cooperative grasping, stabilize-and-pick operations, and simultaneous independent manipulation, which are capabilities previously unavailable on mobile material handling platforms.
2. Unified Pallet-and-Case Handling: Eliminates the need for separate specialized systems for case picking, palletizing, depalletizing, and pallet transport by integrating all functions into a single bi-manual mobile platform.
3. End-to-End Automation: Combines the mobility and heavy-load capacity of autonomous forklifts with the dexterity of coordinated dual-arm manipulators, enabling fully autonomous material handling workflows from receiving through shipping.
4. Fleet-Wide Learning Flywheel: Each robot learns and refines manipulation policies from its own operational experience and shares those learnings fleet-wide, creating an exponentially growing flywheel where collective manipulation intelligence accelerates as more robots are deployed; that is, novel objects learned by one robot immediately benefit the entire fleet.
5. Scalability: As fleet size increases, the rate of collective learning accelerates, providing compounding returns to scale where each additional deployed robot contributes new experiences that improve performance for all robots in the fleet.

### OTHER IMPLEMENTATION OPTIONS

It should be understood that the example embodiments described above may be implemented in many different ways. In some instances, the various “data processors” may each be implemented by a physical or virtual general purpose computer having a central processor, memory, disk or other mass storage, communication interface(s), input/output (I/O) device(s), and other peripherals. The general-purpose computer is transformed into the processors and executes the processes described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system. One or more central processor units are attached to the system bus and provide for the execution of computer instructions. Also attached to system bus are typically I/O device interfaces for connecting disks, memories, and various input and output devices. Network interface(s) allow connections to various other devices. One or more memories provide volatile and/or non-volatile storage for computer software instructions and data used to implement an embodiment. Disks or other mass storage provides non-volatile storage for computer software instructions and data used to implement, for example, the various procedures described herein.

Embodiments may therefore typically be implemented in hardware, custom designed semiconductor logic, Application Specific Integrated Circuits (ASICs), Field Programmable Gate Arrays (FPGAs), firmware, software, or any combination thereof.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); storage including magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

The above description included an explanation of several example embodiments. It should be understood that while a particular feature may have been disclosed with respect to only one of several embodiments, that particular feature may be combined with one or more other features of the other embodiments as may be desired and advantageous for any given or particular application. It is, of course, not possible to describe every conceivable combination of components or methodologies for purposes of describing the innovations herein, and one skill in the art may now, in light of the above description, recognize that many further combinations and permutations are possible. Also, to the extent that the terms “includes,” and “including” and variants thereof are used in either the detailed description or the claims, these terms are intended to be inclusive in a manner similar to the term “comprising”.

It also should be understood that the block and flow diagrams may include more or fewer elements, be arranged differently, or be represented differently. The computing devices, processors, controllers, firmware, software, routines, or instructions as described herein may also perform only certain selected actions and/or functions. Therefore, it will be appreciated that any such descriptions that designate one or more such components as providing only certain functions are merely for convenience.

When a series of steps has been described above with respect to the flow diagrams, the order of the steps may be modified in other implementations. In addition, the operations and steps may be performed by additional or other modules or entities, which may be combined or separated to form other modules or entities. For example, while a series of steps has been described with regard to certain figures, the order of the steps may be modified in other implementations consistent with the principles explained herein. Further, non-dependent steps may be performed in parallel. Further, disclosed implementations may not be limited to any specific combination of hardware.

No element, act, or instruction used herein should be construed as critical or essential to the disclosure unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

Accordingly, the subject matter covered by this patent is intended to embrace all such alterations, modifications, equivalents, and variations that fall within the spirit and scope of the claims that follow.

1. An autonomous material handling system, comprising:
a mobile robotic platform having autonomous navigation capability and configured for material transport in a warehouse environment;
at least one robotic manipulator mounted on said mobile robotic platform, the robotic manipulator providing multiple degrees-of-freedom;
at least one end effector mounted on said at least one robotic manipulator, configured for grasping and manipulating objects;
a perception system comprising at least one sensor configured to detect objects at a target location and determine at least object pose; and
a control system configured to:
(a) process data from said perception system to detect and localize objects,
(b) plan grasp configurations for said at least one robotic manipulator based on detected object properties,
(c) execute manipulation operations using said at least one robotic manipulator to grasp, transport, and place objects, and
(d) coordinate simultaneous autonomous navigation of said mobile robotic platform and manipulation operations by said at least one robotic manipulator.

2. The system of claim 1, wherein said mobile robotic platform comprises an autonomous forklift or an autonomous pallet jack configured for pallet-scale transport, having integrated lift mechanisms capable of raising loads to configurable heights suitable for warehouse rack systems and navigating autonomously using sensor-based localization and mapping.

3. The system of claim 1, wherein said at least one robotic manipulator comprises at least two robotic manipulators configured in a bi-manual arrangement, and wherein said control system is further configured to coordinate said at least two robotic manipulators for bi-manual manipulation tasks including at least one of:
(a) cooperative grasping of objects using both manipulators simultaneously,
(b) stabilize-and-grasp operations where a first manipulator stabilizes a structure while a second manipulator manipulates an object, and
(c) simultaneous independent manipulation of separate objects.

4. The system of claim 1, wherein said perception system comprises: (a) at least one sensor mounted on said mobile robotic platform for navigation and coarse object detection, and (b) at least one sensor mounted on or near a distal end of said at least one robotic manipulator for close-range object perception and grasp planning, wherein said control system uses data from both platform-mounted and manipulator-mounted sensors to perform closed-loop grasp planning, execution, and verification.

5. The system of claim 1, further comprising a plurality of interchangeable end effectors, each adapted for a different manipulation task and employing a different grasping modality, and an automated tool coupling mechanism affixed to said at least one robotic manipulator and configured to autonomously exchange end effectors from said plurality without manual intervention.

6. The system of claim 1, wherein said control system is further configured to select a manipulation strategy for each manipulation task by:
(a) classifying a target object based on detected object properties including at least: object geometry, object pose, and estimated weight,
(b) determining a grasp approach and end effector operating parameters based on said classifying, and
(c) adapting said manipulation strategy in real-time based on sensor feedback received during manipulation execution.

7. The system of claim 1, wherein said system autonomously performs at least two distinct material handling tasks selected from the group consisting of: case picking from palletized loads, palletizing individual cases onto pallets, depalletizing cases from pallets, pallet transport, and order fulfillment involving selection and grouping of heterogeneous items, without requiring manual reconfiguration between said tasks.

8. The system of claim 1, further comprising a fleet coordination module configured to communicate with a fleet management system, share manipulation outcomes with other autonomous material handling systems in a fleet, receive updated manipulation models refined based on fleet-wide experiences, and incorporate said updated models into local control policies to improve subsequent manipulation performance, whereby manipulation performance improves as a number of deployed systems in said fleet increases.

9. A method for autonomous material handling, comprising:
navigating a mobile robotic platform having at least one robotic manipulator to a target location in a warehouse environment;
detecting, using a perception system, one or more objects at said target location;
determining object properties of said one or more objects including at least object pose;
planning a grasp configuration for said at least one robotic manipulator based on said object properties;
executing a manipulation operation comprising grasping at least one object using an end effector on said at least one robotic manipulator, transporting said at least one object, and placing said at least one object at a destination; and
recording an outcome of said manipulation operation including at least sensor data, manipulation parameters, and an outcome indicator for subsequent use in improving manipulation performance.

10. The method of claim 9, wherein said at least one robotic manipulator comprises at least two robotic manipulators, and wherein said executing comprises coordinating said at least two robotic manipulators for at least one of: cooperative grasping of objects using both manipulators simultaneously, stabilize-and-grasp operations where a first manipulator stabilizes a structure while a second manipulator manipulates an object, and simultaneous independent manipulation of separate objects.

11. The method of claim 9, wherein said planning comprises generating a plurality of candidate grasps varying in position, orientation, and end effector parameters, evaluating each candidate grasp using a grasp quality model predicting success probability, and selecting a highest-ranked grasp based on predicted quality and collision-free approach feasibility.

12. The method of claim 9, further comprising adapting said grasp configuration in real-time during execution based on at least one of: force feedback, torque feedback, tactile feedback, and proximity sensor feedback, wherein said adapting comprises at least one of: correcting asymmetric contact, modulating grip force, detecting slip or impending grasp failure and responding by adjusting end effector engagement parameters, and detecting unexpected contact forces and pausing motion to replan.

13. The method of claim 9, further comprising updating a local manipulation model using said recorded outcome and applying said updated local manipulation model to subsequent manipulation operations, whereby said system improves grasp success rates through accumulated operational experience.

14. The method of claim 9, further comprising sharing said recorded outcome with a fleet of autonomous material handling systems by transmitting outcome data to a fleet management system, receiving an updated global model aggregated from manipulation outcomes across said fleet, and incorporating said updated global model into local manipulation policies to improve future performance, whereby each deployed system contributes manipulation experiences that improve the global model for all systems in said fleet.

15. An autonomous material handling system, comprising:
a mobile robotic platform having autonomous navigation capability;
at least one robotic manipulator mounted on said mobile robotic platform;
a plurality of interchangeable end effectors, each adapted for a different manipulation task and employing a different grasping modality selected from the group consisting of jaw-based gripping, vacuum suction, multi-finger articulated gripping, compliant gripping, magnetic gripping, and combinations thereof;
an automated tool coupling mechanism affixed to said at least one robotic manipulator and configured to autonomously engage and disengage end effectors from said plurality without manual intervention, said coupling mechanism comprising:
(a) a master plate affixed to a wrist of said at least one robotic manipulator,
(b) a tool plate affixed to each end effector in said plurality,
(c) an actuation system configured to engage locking elements between said master plate and said tool plate, providing retention force sufficient to securely maintain end effector attachment under operational loads, and
(d) utility pass-through connections providing at least electrical power and digital communication between said robotic manipulator and said end effectors; and
a control system configured to select an end effector from said plurality based on properties of a detected target object and to command said automated tool coupling mechanism to exchange end effectors autonomously.

16. The system of claim 15, wherein said coupling mechanism further comprises redundant locking verification sensors comprising at least two independent sensors that must both confirm secure engagement before manipulation operations are permitted, and a tool identification system configured to uniquely identify each coupled end effector and to verify that a correct end effector is attached for an intended task.

17. A method for distributed learning of robotic manipulation policies across a fleet of autonomous material handling systems, comprising:
at a first autonomous material handling system comprising a mobile robotic platform and at least one robotic manipulator:
(a) executing a plurality of manipulation operations using a local manipulation policy,
(b) recording, for each manipulation operation, sensor data, manipulation parameters, and an outcome indicator specifying success or failure,
(c) updating a local manipulation model using said recorded data, and
(d) generating model update data and transmitting said model update data to a central aggregation server;
at said central aggregation server:
(a) receiving model update data from a plurality of autonomous material handling systems in said fleet,
(b) aggregating said model update data to generate an updated global manipulation policy, and
(c) distributing said updated global manipulation policy to said plurality of autonomous material handling systems; and
at said first autonomous material handling system:
(a) receiving said updated global manipulation policy,
(b) incorporating said updated global manipulation policy into said local manipulation policy, and
(c) executing subsequent manipulation operations using said updated local manipulation policy, whereby each additional deployed system contributes new manipulation experiences that improve the global policy for all systems, creating a compounding learning flywheel that accelerates as fleet size increases.

18. The method of claim 17, wherein said aggregating further comprises filtering received model update data to exclude updates from systems with performance metrics below a quality threshold, validating said updated global manipulation policy against a benchmark, and deploying said updated global manipulation policy only if performance improvement exceeds a deployment threshold, via a staged rollout to said plurality of autonomous material handling systems to mitigate deployment risk.

19. An autonomous material handling system, comprising:
a mobile robotic platform having autonomous navigation capability and comprising platform-level sensors;
at least one robotic manipulator mounted on said mobile robotic platform;
a hierarchical safety system comprising:
(a) platform-level detection utilizing said platform-level sensors to detect and track obstacles and humans in a surrounding environment, classify detected entities, determine positions and poses of detected entities, and maintain a primary safety envelope around said system,
(b) manipulator-level detection utilizing sensors mounted on or near said at least one robotic manipulator to detect obstacles and human presence within a manipulation workspace at closer range than said platform-level sensors, and
(c) end-effector-level detection utilizing sensors integrated into end effectors on said at least one robotic manipulator to detect unexpected contact during manipulation, wherein said hierarchical safety system fuses data across all detection layers to maintain dynamic protective zones surrounding said mobile robotic platform and said at least one robotic manipulator, with zone boundaries adjusted based on at least platform velocity and manipulator configuration; and
a safety control subsystem configured to:
(a) reduce speed when an entity is detected in a warning zone,
(b) trigger a controlled stop when an entity is detected in a protective zone, and
(c) restrict said at least one robotic manipulator to retract-only motion when an entity is detected within said manipulation workspace.

20. The system of claim 19, wherein said platform-level detection further comprises AI-based entity classification that distinguishes humans from other obstacles, determines human body poses, and predicts human motion trajectories, and wherein detected humans receive wider protective zones and lower force thresholds than detected non-human obstacles, and wherein said control system preemptively adjusts manipulator trajectories, speeds, or force limits based on detected proximity to humans before any physical contact occurs.

21. The system of claim 19, further comprising force-limiting mechanisms integrated into said at least one robotic manipulator and end effectors, configured to:
(a) continuously monitor interaction forces during manipulation,
(b) detect unintended contact based on unexpected force patterns distinguishable from expected manipulation contact, wherein said detection is supplemented by spatial awareness from said platform-level and manipulator-level detection layers,
(c) release grip force or halt motion upon detecting unintended contact, with heightened response priority when the unintended contact is identified as human, and
(d) enable collaborative operation modes for human-robot shared workspace operation with power and force limiting while maintaining safety through continuous monitoring across all detection layers.
